(19) United States
(12) Patent Application Publication
(10) Pub. No.: US 2004/0019498 A1
(43) Pub. Date: Jan. 29, 2004

(54) Information management device for printing apparatus and information management method

(75) Inventor: Hironori Matsugi, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/424,980

(22) Filed: Apr. 29, 2003

(30) Foreign Application Priority Data
Apr. 30, 2002 (JP) 2002-127942
Aug. 20, 2002 (JP) 2002-239524
Apr. 25, 2003 (JP) 2003-122966

(51) Int. Cl. G06F 17/60

(52) U.S. Cl. 705/1

(57) ABSTRACT

The technique of the present invention reads image-related data, which includes a print size of each image and an ID of a digital still camera used for shooting the image, from each of printing apparatuses 50a and 50b at regular intervals. The technique sums up the number of printed images in each print size with regard to each manufacturer of the digital still camera and sets a convertible point, where each printed image is shot with the digital still camera of the manufacturer and is printed with either of the printing apparatuses 50a and 50b. The technique then notifies a computer 60a or 60b of the manufacturer of the setting point.

### BACKGROUND OF THE INVENTION

1. Field of the Invention

The present invention relates to an information management device for printing apparatuses and a corresponding information management method. More specifically the invention pertains to an information management device for printing apparatuses, which are connected with multiple printing apparatuses located at different places via a communication line to receive expendable consumption information regarding an expendable consumed at least by the multiple printing apparatuses and thereby to manage a consumption status of the expendable in the multiple printing apparatuses, as well as to a corresponding information management method.

2. Description of the Prior Art

A diversity of information management devices have been proposed to register a point corresponding to a credit settlement amount by each registered customer. The proposed information management device compiles the credit settlement amount by each customer in a predetermined time period, for example, every month, sets a point corresponding to the compiled settlement amount, and accumulates the point with respect to the customer. The accumulated point is typically convertible into an article or a gift voucher, where a certain expiration date is set for such conversion.

The information management device sets and calculates the point for such point registration service offered to each customer who makes credit settlement. The prior art information management device, however, does not set or calculate the point for the point registration service offered to a manufacturer that has manufactured a commodity as the subject of credit settlement or a dealer that has sold such a commodity.

### SUMMARY OF THE INVENTION

The object of the present invention is thus to provide an information management device and a corresponding information management method, which make each image printed with a printing apparatus and automatically set a specified service to a manufacturer of a shooting device, which is used to shoot the image. The object of the present invention is also to provide an information management device and a corresponding information management method, which automatically set a specified service to a manufacturer of a shooting device according to a quantity of an expendable consumed by a printing apparatus in the process of printing each image shot with the shooting device.

In order to achieve at least a part of the aforementioned objects, an information management device for a printing apparatus and a corresponding information management method of the present invention are structured as follows.

A first information management device for a printing apparatus of the present invention is a device being connected with multiple printing apparatuses located at different places via a communication line to receive expendable consumption information regarding an expendable consumed at least by the multiple printing apparatuses and thereby to manage a consumption status of the expendable in the multiple printing apparatuses, the information management device including an image-related information storage module that receives and stores image-related information, which regards an image printed with one of the multiple printing apparatuses and a shooting device used for shooting the image, from each of the multiple printing apparatuses via the communication line and a specified service setting module that sets a specified service to a manufacturer of the shooting device, based on the received image-related information.

The first information management device of the present invention receives via the communication line the image-related information regarding each image printed with one of the multiple printing apparatuses, which are located at different places and are connected with the information management device via the communication line, and the shooting device used for shooting the image, and sets the specified service to the manufacturer of the shooting device based on the received image-related information. This arrangement automatically sets the specified service to the manufacturer of the shooting device, which is used to shoot an object image to be printed, based on the image-related information regarding the object image printed with one of the multiple printing apparatuses located at different places.

A second information management device for a printing apparatus of the present invention is a device being connected with multiple printing apparatuses, which are located at different places and are capable of laying out and printing multiple images on an identical sheet of printing paper, via a communication line to manage printing-related information in the multiple printing apparatuses, the information management device including: an image-related information storage module that receives and stores image-related information, which regards an image laid on the sheet of printing paper and printed with one of the multiple printing apparatuses and a shooting device used for shooting the image, from each of the multiple printing apparatuses via the communication line; an occupation rate computation module that computes an occupation rate of the printed image relative to the printing paper, based on the received image-related information; and an information management module that manages the computed occupation rate in relation to the image-related information.

The second information management device of the present invention receives via the communication line the image-related information regarding each image laid out on the printing paper and printed with one of the multiple printing apparatuses, which are located at different places and are capable of printing multiple images laid on an identical sheet of printing paper and the shooting device used for shooting the image, and computes the occupation rate of each printed image relative to the printing paper based on the received image-related information, and manages the computed occupation rate in relation to the image-related information. In the case where multiple images are printed on an identical sheet of printing paper, the technique of the invention manages the occupation rate of each image relative to the printing paper in relation to the printing paper and the shooting device used for shooting the image. This arrangement ensures meticulous management of the printing-related information in the multiple printing apparatuses. Here, the information management module may include a specified service setting module that sets a specified service to a manufacturer of the shooting device, which is used to shoot each image, according to the computed occupation rate.

In the first information management device and the second information management device of the present invention, as one aspect, the specified service setting module may compile consumption of the expendable consumed by the multiple printing apparatuses in the process of printing images shot with the shooting device manufactured by the manufacturer, with respect to each manufacturer of the shooting device and set the specified service to the manufacturer according to the compiled consumption of the expendable. In this case, the specified service setting module may compile quantity of printing paper, on which the images are printed, in each print size as the consumption of the expendable and set a more advantageous level of the specified service to the manufacturer according to a greater quantity of the compiled consumption of the expendable.

In the first information management device and the second information management device of the present invention, as another aspect, the specified service setting module may set a point convertible into either of an article and money as the specified service, an amount of money to be paid to the manufacturer as the specified service, and the specified service at every preset time interval.

In the first information management device and the second information management device of the present invention, as still another aspect, there may be provided with a service details output module that outputs either of a document and a display window including details of the setting of the specified service to a computer of the manufacturer via the communication line.

The technique of the present invention is not restricted to the information management device for printing apparatuses, but is also applicable to an information management method for printing apparatuses.

### BRIEF DESCRIPTION OF THE DRAWINGS

FIG. 1 schematically illustrates the construction of a printing management system 20 including an information management device 30 in one embodiment of the invention;

FIG. 2 is a flowchart showing an information input routine executed by the information management device 30;

FIG. 3 shows an example of the expendable consumption data;

FIG. 4 shows an example of the image-related data;

FIG. 5 is a flowchart showing a point setting notification routine executed by the information management device 30;

FIG. 6 is a flowchart showing an information input routine executed by an information management device 30B in a second embodiment;

FIG. 7 shows an example of the image-related data used in the second embodiment;

FIG. 8 shows a print layout of three images 1, 2, and 3;

FIG. 9 shows one example of the data structure where the occupation rate of each image is calculated and is added to the image-related data; and

FIG. 10 is a flowchart showing a point setting notification routine executed by the information management device 30B in the second embodiment.

### DESCRIPTION OF THE PREFERRED EMBODIMENTS

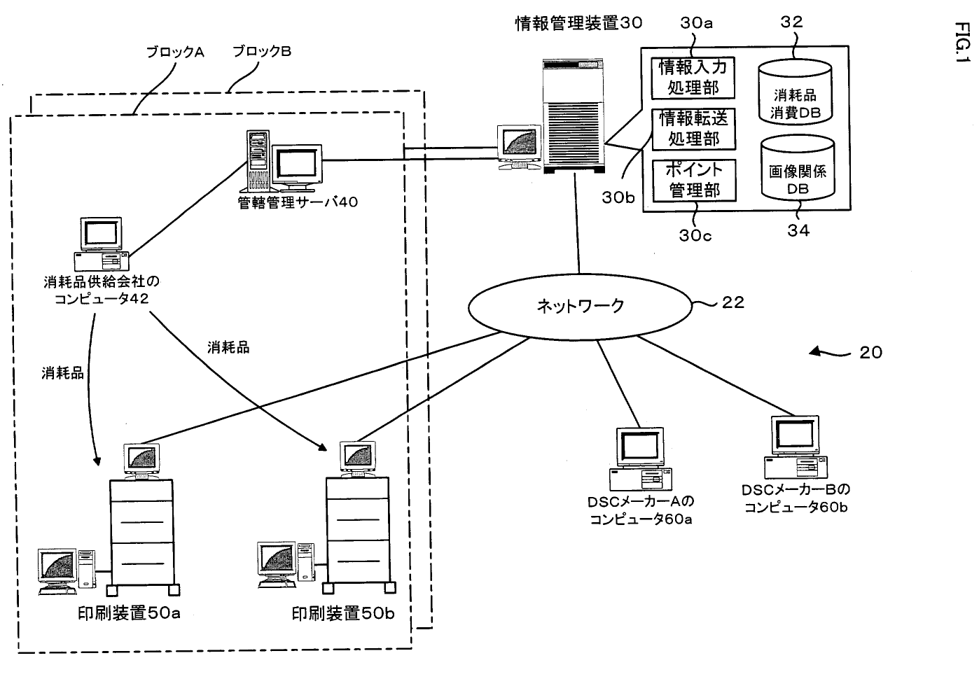

Preferred embodiments of the present invention are discussed below. FIG. 1 schematically illustrates the construction of a printing management system 20 including an information management device 30 in one embodiment of the invention. As illustrated, the information management device 30 of the embodiment includes an information input module 30a that acquires data regarding consumption of expendables (hereafter referred to as expendable consumption data) and data regarding printed images (hereafter referred to as image-related data) from multiple printing apparatuses 50a and 50b, which connect with the information management device 30 via a network 22, at regular intervals, and an information transfer module 30b that transfers the expendable consumption data to a jurisdiction management server 40, which manages supplies of expendables used in the multiple printing apparatuses 50a and 50b. The information management device 30 also includes a point management module 30c that sets a convertible point in each manufacturer of the digital still camera, which is used to shoot the printed image, based on the image-related data, and notifies computers 60a and 60b in the respective manufacturers of the digital still camera, which connect with the information management device 30 via the network 22, of the setting points, an expendable consumption database 32 that stores the expendable consumption data in the form of a database, and an image-related database 34 that stores the image-related data in the form of a database.

The jurisdiction management server 40 functions to manage supplies of expendables for the printing apparatuses 50a and 50b, which are located at a photo studio in each of geographical blocks (for example, a block A and a block B in the drawing). The jurisdiction management server 40 outputs a supply instruction to a computer 42 of an expendable supplier, which supplies expendables, such as printing papers and printing inks, used at the photo studio to keep predetermined stocks, based on the expendable consumption data transferred from the information management device 30. The series of processing executed by the jurisdiction management server 30 is not the essential part of the present invention and is not described in detail here. The following describes the series of processing executed by the information management device 30 of the embodiment.

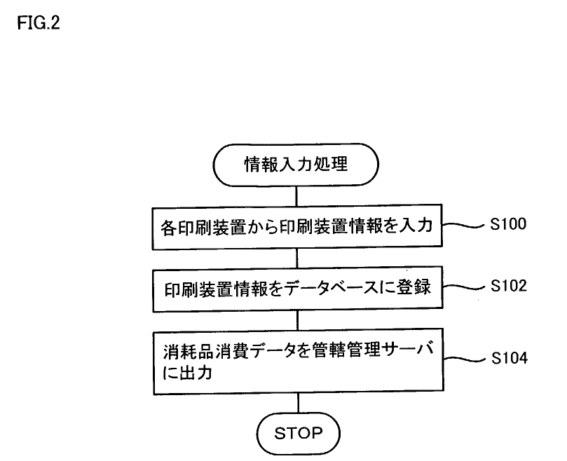

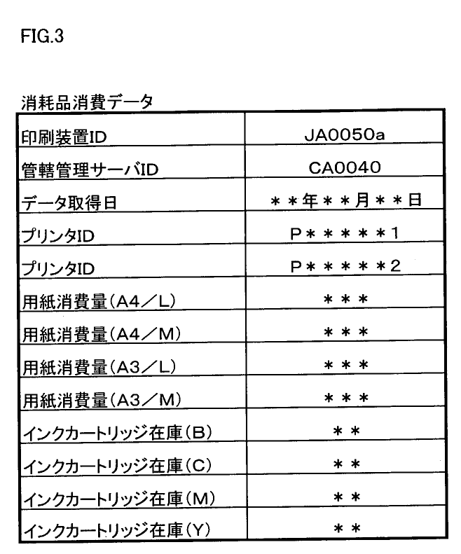

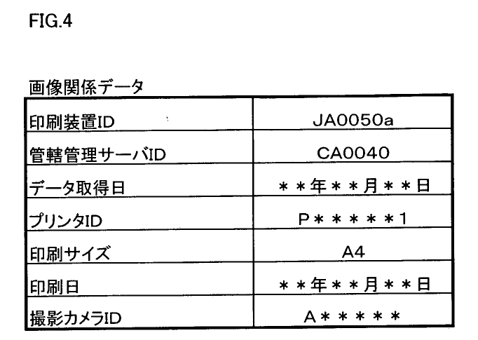

FIG. 2 is a flowchart showing an information input routine executed by the information input module 30a and the information transfer module 30b included in the information management device 30 of the embodiment. This information input routine is carried out iteratively at preset time intervals (for example, at every 24 hours). When the program enters the information input routine, the information management device 30 of the embodiment first inputs printing apparatus-related information including the expendable consumption data and the image-related data from each of the printing apparatuses 50a and 50b in all geographical blocks connecting with the information management device 30 via the network 22 (step S100). FIG. 3 shows an example of the expendable consumption data, and FIG. 4 shows an example of the image-related data. As shown in FIG. 3, the expendable consumption data of the embodiment includes a printing apparatus ID allocated to each printing apparatus, a jurisdiction management server ID allocated to each jurisdiction management server, a data acquisition date as the information input date from the printing apparatus, a printer ID allocated to each printer incorporated in the printing apparatus, a consumption of each printing paper, and a stock of each ink cartridge in each color used for printing. As shown in FIG. 4, the image-related data includes the printing apparatus ID, the jurisdiction management server ID, the data acquisition date as the information input date from the printing apparatus, a printer ID allocated to a printer actually used for printing an image, a print size of the printed image, a printing date as the date of printing the image, and an ID allocated to a digital still camera (camera ID) used for shooting the printed image. The digital still camera used for shooting the image is designed to write its ID, for example, into a header of an image file in the process of file generation. The printing apparatus 50a or 50b reads the image file and obtains the ID of the digital still camera from the header of the image file to be incorporated as the camera ID into the image-related data.

After reading the printing apparatus-related information, the information management device 30 registers the expendable consumption data of the printing apparatus-related information into the expendable consumption database 32, while registering the image-related data into the image-related database 34 (step S102). The registered expendable consumption data are output to the jurisdiction management server 40 having an allocated ID identical with the input jurisdiction management server ID (step S104). The program then exits from this information input routine. As mentioned previously, the jurisdiction management server 40 receives the expendable consumption data from the information management device 30 and manages supplies of expendables by the expendable supplier to each photo studio, where the printing apparatus is located, in the geographical block under jurisdiction, based on the received expendable consumption data.

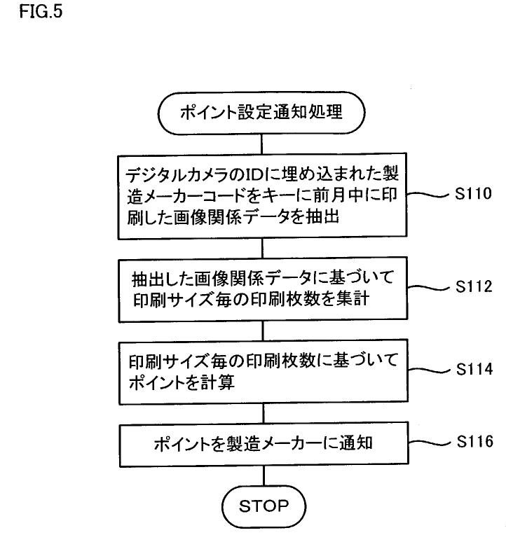

FIG. 5 is a flowchart showing a point setting notification routine executed by the point management module 30c included in the information management device 30 of the embodiment. This routine is executed on the 1^{st} day of every month. When the program enters the point setting notification routine, the information management device 30 of the embodiment first extracts the image-related data as data regarding images printed in a previous month with regard to each manufacturer of the digital still camera from the image-related database 34, with a code of the manufacturer of the digital still camera embedded in the ID of the digital still camera (camera ID) as the key (step S110). In the structure of this embodiment, the first letter of the camera ID included in-the image-related data is assigned as the code of the manufacturer of the digital still camera. Extraction of the image-related data is accordingly based on the first letter of the camera ID as the code of the manufacturer and the printing date.

After extraction of the image-related data regarding the images printed in the previous month with regard to each manufacturer of the digital still camera, the information management device 30 sums up the number of printed images in each print size, based on the print size included in the extracted image-related data (step S112). The resulting sum-up data are, for example, XX prints in a size A4 and YY prints in a size A3, as the number of printed images in each print size, where the printed images were shot with a digital still camera of a manufacturer A and were printed with any of the printing apparatuses in the previous month. The information management device 30 subsequently multiplies the number of printed images in each print size summed up with regard to each manufacturer of the digital still camera by a preset point for each print size, so as to calculate a total point (step S114). For example, when the settings are 10 points for the size A4 and 20 points for the size A3, the summation of the point is carried out by multiplying the summed up number of prints in each print size by the setting of the point.

The computer 60a or 60b of the corresponding manufacturer of the digital still camera connecting with the information management device 30 via the network 22 is then notified of the calculated total point (step S116). The program here exits from the point setting notification routine. In the structure of this embodiment, the notified point is converted into money at a preset rate and is remitted to the corresponding manufacturer of the digital still camera as one service offered to the manufacturer. The manufacturer, which is notified of the calculated total point, thus gains a sum of money specified by the notified point. This service encourages the manufacturer of the digital still camera to promote a further spread of the digital still camera and recommend printing with the printing apparatuses 50a and 50b in the printing management system 20 of the embodiment. Notification of the point to the computer 60a or 60b of the corresponding manufacturer of the digital still camera may be implemented by simple transfer of data, by creation and transmission of an electronic document, or by any other suitable technique.

As described above, the information management device 30 of the embodiment automatically offers the point registration service as the predetermined service to each manufacturer of the digital still camera, which is used to shoot images, based on the image-related data regarding images printed with the multiple printing apparatuses 50a and 50b located at different places. The point is calculated from the number of printed images in each print size. The point registration service is thus given to the manufacturer of the digital still camera according to the quantities of expendables consumed by the printing apparatuses 50a and 50b. This point registration service desirably enhances the efficiency of the system.

The information management device 30 of the embodiment extracts the image-related data of every month with regard to each manufacturer, calculates the total point based on the extracted image-related data, and notifies the manufacturer of the calculated total point. The calculation frequency of the total point is not restricted to once a month, but the calculation may be performed at any desired frequency. It is not necessary to notify the manufacturer of the calculated total point every time the total point is calculated. The notification may be carried out at another frequency at different timings.

The information management device 30 of the embodiment extracts the image-related data with regard to each manufacturer of the digital still camera with the code of the manufacturer embedded in the camera ID as the key and calculates the point based on the extracted image-related data. One modified procedure may extract the image-related data with regard to each digital still camera with the camera ID as the key, calculate the point based on the extracted image-related data, and compile the calculated point with regard to each manufacturer of the digital still camera.

The information management device 30 of the embodiment sums up the number of prints in each print size with regard to each manufacturer of the digital still camera and multiplies the summed up number of prints in each print size by a preset point for each print size, so as to calculate the total point. One modified procedure may compile a printing area from the print size included in each image-related data with regard to each manufacturer of the digital still camera and multiply the compiled printing area by a preset point for each unit area, so as to calculate the total point.

The information management device 30 of the embodiment sets the convertible point as the service offered to each manufacturer of the digital still camera. One possible modification may set an inconvertible point as the service to each manufacturer of the digital still camera. Another possible modification may directly set an amount of money to be paid to each manufacturer of the digital still camera, instead of the point.

The information management device 30 of the embodiment notifies the calculated total point to the computer 60a or 60b of the corresponding manufacturer of the digital still camera via the network 22. One modified procedure may notify each manufacturer of the digital still camera of the calculated total point by post or by another suitable technique.

In the above embodiment, the technique of the present invention is applied to the information management device 30 that manages information of multiple printing apparatuses. The technique of the invention is also applicable to an information management method described above in relation to the information management device 30 of the embodiment. Another application is a program that causes the computer to function as the information management device 30 of the embodiment. Still another application is a program that causes the computer to execute the respective steps of the information management method described above in relation to the information management device 30 of the embodiment. In the case of such programs, the respective steps of the information input routine shown in FIG. 2 and the point setting notification routine shown in FIG. 5 may be programmed in a suitable programming language.

Another information management device 30B and another printing management system 20B are discussed below as a second embodiment of the present invention. The information management device 30B and the printing management system 20B of the second embodiment have an identical hardware structure with that of the information management device 30 and the printing management system 20 of the first embodiment illustrated in FIG. 1, although the respective constituents expressed by the functional blocks may have different functions. The same hardware constituents in the information management device 30B and the printing management system 20B of the second embodiment as those in the information management device 30 and the printing management system 20 of the first embodiment are expressed by the same numerals and symbols and are not specifically described here to avoid duplicated explanation. The following description regards series of processing executed by the information management device 30B of the second embodiment.

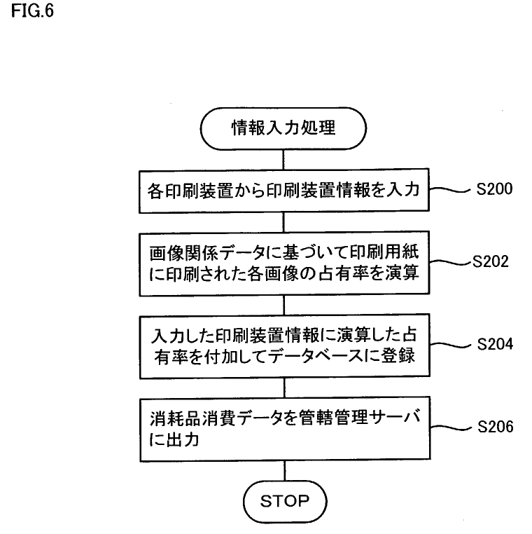

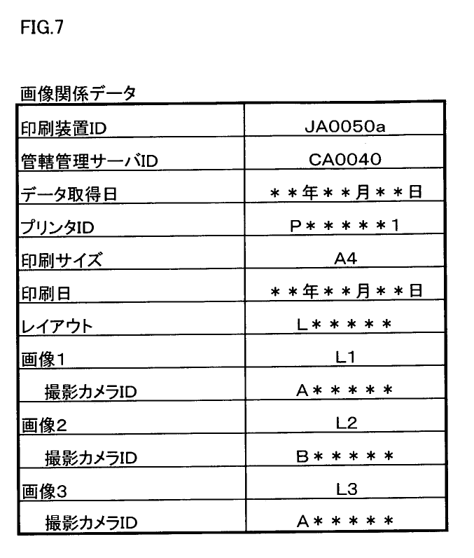

FIG. 6 is a flowchart showing an information input routine executed by the information input module 30a and the information transfer module 30b included in the information management device 30B of the second embodiment. This information input routine is carried out iteratively at preset time intervals (for example, at every 24 hours). When the program enters the information input routine, the information management device 30B of the second embodiment first inputs the printing apparatus-related information including the expendable consumption data and the image-related data from each of the printing apparatuses 50a and 50b in all geographical blocks connecting with the information management device 30B via the network 22 (step S200). Like the first embodiment shown in FIG. 3, the expendable consumption data input here includes the printing apparatus ID, the jurisdiction management server ID, the data acquisition date as the date of inputting the information from the printing apparatus, the printer ID allocated to each printer incorporated in the printing apparatus, the consumption of each printing paper, and the stock of each ink cartridge in each color used for printing. As shown in FIG. 7, the image-related data includes a layout of multiple printed images on the printing paper and an ID allocated to each digital still camera (camera ID) used for shooting each of the multiple images, in addition to the data elements of the first embodiment, that is, the printing apparatus ID, the jurisdiction management server ID, the data acquisition date as the date of inputting the information from the printing apparatus, the printer ID used for printing the images, the print size of printing the images, and the printing date as the date of printing the images. The layout may be specified by positioning each image with the upper left coordinates and the lower right coordinates of the image relative to the absolute coordinates of the printing paper. The layout may otherwise be set by selecting one among desired available options. In the latter case, the layout may be specified by an ID allocated to the selected layout. The procedure of this embodiment specifies the layout with a set of the coordinates. The layout includes multiple data representing sets of the upper left coordinates and the lower right coordinates of the respective images arranged on the printing paper. The image-related data of this embodiment has sets of each image and the camera ID used for shooting the image, subsequent to the layout, in the sequence of the multiple data of the layout. As discussed in the first embodiment, the digital still camera used for shooting each image is designed to write its ID, for example, into a header of an image file in the process of file generation. The printing apparatus 50a or 50b reads the image file and obtains the ID of the digital still camera from the header of the image file to be incorporated as the camera ID into the image-related data.

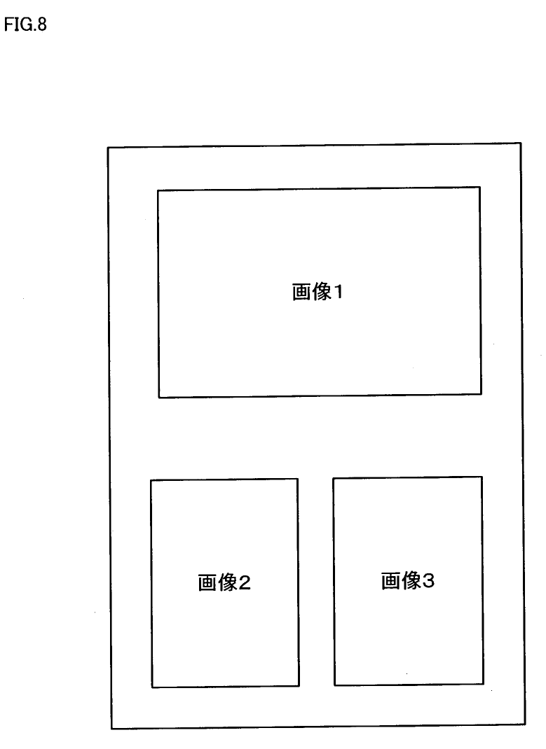

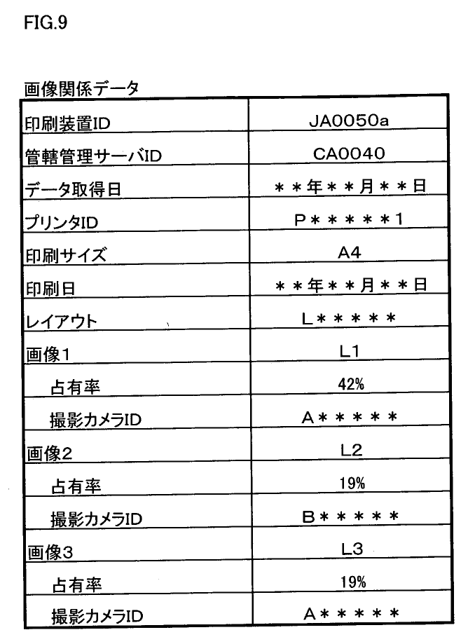

After reading the printing apparatus-related information, the information management device 30B calculates an occupation rate of each image printed on the printing paper, based on the image-related data included in the received printing apparatus-related information (step S202). The occupation rate of each image may be calculated from the layout of the image-related data. In the procedure of this embodiment, the layout is specified by positioning each image with the set of the upper left coordinates and the lower right coordinates. The occupation rate of each image is thus calculated as the ratio of the area of each image to the total area of the printing paper from the set of coordinates relative to the coordinates of the whole printing paper. FIG. 8 shows a print layout of three images 1, 2, and 3. FIG. 9 shows one example of the data structure where the occupation rate of each image is calculated and is added to the image-related data.

The information management device 30B registers the expendable consumption data of the input printing apparatus-related information into the expendable consumption database 32, while registering the image-related data with the occupation rate of each image added thereto into the image-related database 34 (step S204). The registered expendable consumption data are output to the jurisdiction management server 40 having the ID identical with the jurisdiction management server ID (step S206). The program then exits from the information input routine. Like the first embodiment, in the structure of the second embodiment, the jurisdiction management server 40 receives the expendable consumption data from the information management device 30B and manages supplies of expendables by the expendable supplier to each photo studio, where the printing apparatus is located, in the geographical block under jurisdiction, based on the received expendable consumption data.

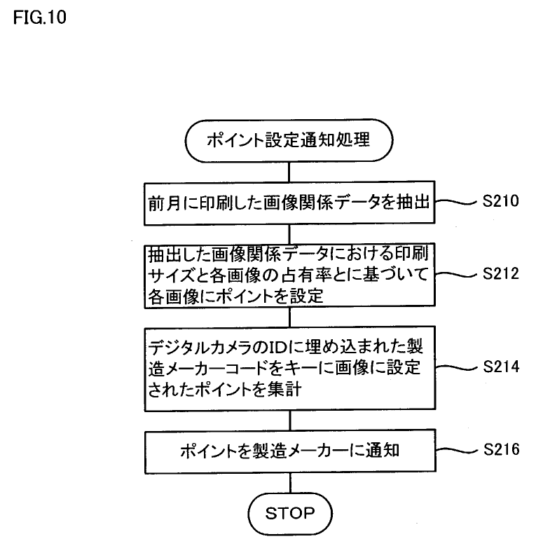

FIG. 10 is a flowchart showing a point setting notification routine executed by the point management module 30c included in the information management device 30B of the second embodiment. This routine is executed on the 1^{st} day of every month. When the program enters the point setting notification routine, the information management device 30B of the second embodiment first extracts the image-related data regarding images printed in a previous month from the image-related database 34 (step S210), and subsequently specifies a point for each image, based on the print size and the occupation rate of each image included in the extracted image-related data (step S212). The procedure of this embodiment multiples a preset point for each print size by the occupation rate of each image, so as to specify the point for each image. The greater point is set for the greater print size.

After specifying the point for each image, the information management device 30 B compiles the point specified for each image with regard to each manufacturer of the digital still camera, with a code of the manufacturer embedded in the ID of the digital still camera (camera ID) as the key (step S214). As in the case of the first embodiment, the first letter of the camera ID is assigned as the code of the manufacturer of the digital still camera. Compilation of the point specified for each image is accordingly implemented by summing up the point of each image shot with the digital still camera having the camera ID including the first letter identical with the code of the manufacturer of the digital still camera.

The computer 60a or 60b of the corresponding manufacturer of the digital still camera connecting with the information management device 30B via the network 22 is then notified of the compiled point (step S216). The program here exits from the point setting notification routine. In the structure of the second embodiment, the notified point is converted into money at a preset rate and is remitted to the corresponding manufacturer of the digital still camera as one service offered to the manufacturer. The manufacturer, which is notified of the calculated total point, thus gains a sum of money specified by the notified point. This service encourages the manufacturer of the digital still camera to promote a further spread of the digital still camera and recommend printing with the printing apparatuses 50a and 50b in the printing management system 20B of the second embodiment. Notification of the point to the computer 60a or 60b of the corresponding manufacturer of the digital still camera may be implemented by simple transfer of data, by creation and transmission of an electronic document, or by any other suitable technique.

As described above, the information management device 30B of the second embodiment manages the occupation rate of each image on the printing paper in relation to the ID of the digital still camera used for shooting the image (camera ID), and thereby attains meticulous management of information on printing with the multiple printing apparatuses 50a and 50b. The procedure of this embodiment automatically offers the point registration service as the predetermined service to the manufacturer of the digital still camera used to shoot each image, based on the occupation rate of the image. This point registration service desirably enhances the efficiency of the system.

The information management device 30B of the second embodiment specifies the point for each image based on the occupation rate of the image, compiles the specified point, and notifies the manufacturer of the digital still camera, which is used to shoot each image, of the compiled point as the predetermined service. One modified procedure may not specify the point for each image, based on the occupation rate of the image. The modified procedure may offer another management to the manufacturer of the digital still camera used to shoot each image, based on the occupation rate of the image, for example, may notify the manufacturer of information regarding the working status of the digital still camera.

The information management device 30B of the second embodiment inputs the expendable consumption data and transmits the input expendable consumption data to the jurisdiction management server 40 to manage the consumption status of expendables in the multiple printing apparatuses 50a and 50b. One modified procedure may not input the expendable consumption data and thereby not manage the consumption status of expendables in the multiple printing apparatuses 50a and 50b.

The information management device 30B of the second embodiment extracts the image-related data of every month, compiles the point, and notifies the manufacturer of the compiled point. The compilation frequency of the point is not restricted to once a month, but the compilation may be performed at any desired frequency. It is not necessary to notify the manufacturer of the complied point every time the point is complied. The notification may be carried out at another frequency at different timings.

The information management device 30B of the second embodiment sets the convertible point as the service offered to each manufacturer of the digital still camera. One possible modification may set an inconvertible point as the service to each manufacturer of the digital still camera. Another possible modification may directly set an amount of money to be paid to each manufacturer of the digital still camera, instead of the point.

The information management device 30B of the second embodiment notifies the compiled point to the computer 60a or 60b of the corresponding manufacturer of the digital still camera via the network 22. One modified procedure may notify each manufacturer of the digital still camera of the compiled point by post or by another suitable technique.

In the second embodiment described above, the technique of the present invention is applied to the information management device 30B that manages information of multiple printing apparatuses. The technique of the invention is also applicable to an information management method described above in relation to the information management device 30B of the second embodiment. Another application is a program that causes the computer to function as the information management device 30B of the second embodiment. Still another application is a program that causes the computer to execute the respective steps of the information management method described above in relation to the information management device 30B of the second embodiment. In the case of such programs, the respective steps of the information input routine shown in FIG. 6 and the point setting notification routine shown in FIG. 10 may be programmed in a suitable programming language.

The above embodiments are to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

What is claimed is:

1. An information management device for a printing apparatus, said information management device being connected with multiple printing apparatuses located at different places via a communication line to receive expendable consumption information regarding an expendable consumed at least by the multiple printing apparatuses and thereby to manage a consumption status of the expendable in the multiple printing apparatuses,
said information management device comprising:
an image-related information storage module that receives and stores image-related information, which regards an image printed with one of the multiple printing apparatuses and a shooting device used for shooting the image, from each of the multiple printing apparatuses via the communication line; and
a specified service setting module that sets a specified service to a manufacturer of the shooting device, based on the received image-related information.

2. An information management device in accordance with claim 1, wherein said specified service setting module compiles consumption of the expendable consumed by the multiple printing apparatuses in the process of printing images shot with the shooting device manufactured by the manufacturer, with respect to each manufacturer of the shooting device and sets the specified service to the manufacturer according to the compiled consumption of the expendable.

3. An information management device in accordance with claim 2, wherein said specified service setting module compiles quantity of printing paper, on which the images are printed, in each print size as the consumption of the expendable.

4. An information management device in accordance with claim 2, wherein said specified service setting module sets a more advantageous level of the specified service to the manufacturer according to a greater quantity of the compiled consumption of the expendable.

5. An information management device in accordance with claim 1, wherein said specified service setting module sets a point convertible into either of an article and money as the specified service.

6. An information management device in accordance with claim 1, wherein said specified service setting module sets an amount of money to be paid to the manufacturer as the specified service.

7. An information management device in accordance with claim 1, wherein said specified service setting module sets the specified service at every preset time interval.

8. An information management device in accordance with claim 1, said information management device further comprising:
a service details output module that outputs either of a document and a display window including details of the setting of the specified service to a computer of the manufacturer via the communication line.

9. An information management device in accordance with claim 1, wherein the image-related information includes device identification information for identifying the shooting device, and
said specified service setting module compiles the image-related information stored in said image-related information storage module with respect to each piece of the device identification information and sets the specified service to the manufacturer of the shooting device identified by the piece of the device identification information.

10. An information management device for a printing apparatus, said information management device being connected with multiple printing apparatuses, which are located at different places and are capable of laying out and printing multiple images on an identical sheet of printing paper, via a communication line to manage printing-related information in the multiple printing apparatuses,
said information management device comprising:
an image-related information storage module that receives and stores image-related information, which regards an image laid on the sheet of printing paper and printed with one of the multiple printing apparatuses and a shooting device used for shooting the image, from each of the multiple printing apparatuses via the communication line;
an occupation rate computation module that computes an occupation rate of the printed image relative to the printing paper, based on the received image-related information; and
an information management module that manages the computed occupation rate in relation to the image-related information.

11. An information management device in accordance with claim 10, wherein said information management module comprises a specified service setting module that sets a specified service to a manufacturer of the shooting device, which is used to shoot each image, according to the computed occupation rate.

12. An information management device in accordance with claim 11, wherein said specified service setting module compiles consumption of the expendable consumed by the multiple printing apparatuses in the process of printing images shot with the shooting device manufactured by the manufacturer, with respect to each manufacturer of the shooting device and sets the specified service to the manufacturer according to the compiled consumption of the expendable.

13. An information management device in accordance with claim 12, wherein said specified service setting module compiles quantity of printing paper, on which the images are printed, in each print size as the consumption of the expendable.

14. An information management device in accordance with claim 11, said information management device further comprising:
a service details output module that outputs either of a document and a display window including details of the setting of the specified service to a computer of the manufacturer via the communication line.

15. An information management device in accordance with claim 11, wherein the image-related information includes device identification information for identifying the shooting device and a size of the printing paper, and
said specified service setting module calculates a value corresponding to a product of the computed occupation rate and the printing paper size included in the image-related information for each image included in the image-related information stored in said image-related information storage module, compiles the calculated value with respect to each piece of the device identification information, and sets the specified service to the manufacturer of the shooting device identified by the piece of the device identification information, according to the compiled value.

16. An information management method for a device for a printing apparatus, wherein said device being connected with multiple printing apparatuses located at different places via a communication line to receive expendable consumption information regarding an expendable consumed at least by the multiple printing apparatuses and thereby to manage a consumption status of the expendable in the multiple printing apparatuses,
said information management method comprising the steps of:
(a) receiving image-related information, which regards an image printed with one of the multiple printing apparatuses and a shooting device used for shooting the image, from each of the multiple printing apparatuses via the communication line; and
(b) setting a specified service to a manufacturer of the shooting device, based on the received image-related information.

17. An information management method in accordance with claim 16, wherein said step(b) includes the steps of:
(b1) compiling consumption of the expendable consumed by the multiple printing apparatuses in the process of printing images shot with the shooting device manufactured by the manufacturer, with respect to each manufacturer of the shooting device; and
(b2) setting the specified service to the manufacturer according to the compiled consumption of the expendable.

18. An information management method in accordance with claim 17, wherein said step(b1) compiles quantity of printing paper, on which the images are printed, in each print size as the consumption of the expendable.

19. An information management method in accordance with claim 16, said information management method further comprising the step of:
outputting either of a document and a display window including details of the setting of the specified service to a computer of the manufacturer via the communication line.

20. An information management method in accordance with claim 16, wherein the image-related information includes device identification information for identifying the shooting device, and
said step(b) compiles the image-related information stored in said image-related information storage module with respect to each piece of the device identification information and sets the specified service to the manufacturer of the shooting device identified by the piece of the device identification information.

21. An information management method for a device for a printing apparatus, said device being connected with multiple printing apparatuses, which are located at different places and are capable of laying out and printing multiple images on an identical sheet of printing paper, via a communication line to manage printing-related information in the multiple printing apparatuses,
said information management method comprising the steps of:
(a) receiving image-related information, which regards an image laid on the sheet of printing paper and printed with one of the multiple printing apparatuses and a shooting device used for shooting the image, from each of the multiple printing apparatuses via the communication line;
(b) computing an occupation rate of the printed image relative to the printing paper, based on the received image-related information; and
(c) managing the computed occupation rate in relation to the image-related information.

22. An information management method in accordance with claim 21, wherein said step(c) sets a specified service to a manufacturer of the shooting device, which is used to shoot each image, according to the computed occupation rate.

23. An information management method in accordance with claim 22, wherein said step(c) includes the steps of:
(c1) compiling consumption of the expendable consumed by the multiple printing apparatuses in the process of printing images shot with the shooting device manufactured by the manufacturer, with respect to each manufacturer of the shooting device; and
(c2) setting the specified service to the manufacturer according to the compiled consumption of the expendable.

24. An information management method in accordance with claim 23, wherein said step(c1) compiles quantity of printing paper, on which the images are printed, in each print size as the consumption of the expendable.

25. An information management method in accordance with claim 22, said information management method further comprising the step of:
outputting either of a document and a display window including details of the setting of the specified service to a computer of the manufacturer via the communication line.

26. An information management method in accordance with claim 22, wherein the image-related information includes device identification information for identifying the shooting device and a size of the printing paper, and
said step(c) calculates a value corresponding to a product of the computed occupation rate and the printing paper size included in the image-related information for each image included in the image-related information stored in said image-related information storage module, compiles the calculated value with respect to each piece of the device identification information, and sets the specified service to the manufacturer of the shooting device identified by the piece of the device identification information, according to the compiled value.

27. A storage medium in which a computer program is stored, said computer program causing a computer, which is connected with multiple printing apparatuses located at different places via a communication line, to receive expendable consumption information regarding an expendable consumed at least by the multiple printing apparatuses and thereby to manage a consumption status of the expendable in the multiple printing apparatuses,
said computer program comprising:
a module that receives image-related information, which regards an image printed with one of the multiple printing apparatuses and a shooting device used for shooting the image, from each of the multiple printing apparatuses via the communication line; and
a module that sets a specified service to a manufacturer of the shooting device, based on the received image-related information.

28. A storage medium in which a computer program is stored, said computer program causing a computer, which is connected with multiple printing apparatuses, which are located at different places and are capable of laying out and printing multiple images on an identical sheet of printing paper, via a communication line, to manage printing-related information in the multiple printing apparatuses
said computer program comprising:
(a) a module that receives image-related information, which regards an image laid on the sheet of printing paper and printed with one of the multiple printing apparatuses and a shooting device used for shooting the image, from each of the multiple printing apparatuses via the communication line;
(b) a module that computes an occupation rate of the printed image relative to the printing paper, based on the received image-related information; and
(c) a module that manages the computed occupation rate in relation to the image-related information.
